(19) United States
(12) Patent Application Publication
(10) Pub. No.: US 2011/0058558 A1
(43) Pub. Date: Mar. 10, 2011

(54) NETWORK CONTROL DEVICE AND NETWORK CONTROL METHOD

(75) Inventors: Sun Me KIM, Daejeon (KR); Eun Young CHO, Daejeon (KR); Ho Young SONG, Daejeon (KR)

(73) Assignee: Electronics and Telecommunications Research Institute, Daejeon (KR)

(21) Appl. No.: 12/877,518

(22) Filed: Sep. 8, 2010

(30) Foreign Application Priority Data
Sep. 8, 2009 (KR) 10-2009-0084624
Aug. 26, 2010 (KR) 10-2010-0083076

(51) Int. Cl. H04L 12/56

(52) U.S. Cl. 370/395.1

(57) ABSTRACT

A network control device includes a command receiver receiving a command with respect to operation policies of a plurality of maintenance associations (MAs) that construct a single call, a message generator generating a message including information about the operation policies of the plurality of MAs according to the command, and a message transmitter transmitting the message to a neighboring network control device.

### CROSS-REFERENCE TO RELATED APPLICATION

This application claims priority to and the benefit of Korean Patent Application No. 10-2009-0084624 and 10-2010-0083076 filed in the Korean Intellectual Property Office on Sep. 8, 2009 and Aug. 26, 2010, the entire contents of which are incorporated herein by reference.

### BACKGROUND OF THE INVENTION

(a) Field of the Invention

The present invention relates to a network control device and a network control method.

(b) Description of the Related Art

Resource reservation protocol-traffic engineering (RSVP-TE) is a protocol for administrating setup and cancellation of a label switched path (LSP) of an Internet protocol (IP) layer, an asynchronous transfer mode (ATM) layer, Ethernet, and an optic network layer.

The label switched path means a path through which a packet with a label written at the head thereof passes to a destination at a high speed. The label switched path corresponds to a path from an ingress node to an egress node.

To secure continuity of the label switched path and manage faults and performance, a configuration for performing an operation and maintenance (OAM) function at the ingress node, the egress node, and a transit node of the label switched path is required. In conventional networks, the OAM function is manually set by an operator.

However, when a single label switch path passes through domains of multiple service providers and multiple administration domains of a single service provider, it is difficult to automatically set up different OAM functions for respective domains through RSVT-TE signaling. That is, the prior arts can only set up OAM for a single OAM administration domain.

### SUMMARY OF THE INVENTION

The present invention has been made in an effort to provide a device and a method for setting OAM maintenance associations (MAs) of multiple levels and multiple domains in a single label switched path, and configuring and controlling information on different OAMs to be performed by nodes that construct the label switched path for the respective MAs.

A network control device according to an exemplary embodiment of the present invention includes a command receiver receiving a command with respect to operation policies of a plurality of maintenance associations (MAs) that construct a single call, a message generator generating a message including information about the operation policies of the plurality of MAs according to the command, and a message transmitter transmitting the message to a neighboring network control device.

The network control device may further include a message receiver receiving the message from the neighboring network control device, an information extractor extracting information about the operation policy of an MA corresponding to the network control device among the plurality of MAs from the message, and a setup unit setting up an operation and maintenance (OAM) policy in a data plane according to the extracted information.

The message may include identifiers of the plurality of MAs.

The message may include at least one of the Internet protocol (IP) address of a maintenance association end point (MEP) and the IP address of a remote maintenance association end point (R-MEP).

The message may include at least one of information about a continuity check function and information about a performance monitoring function.

The plurality of MAs may be related to one of a plurality of maintenance domains (MDs) set to multiple levels according to administrators.

The message may include information about the MDs.

The message may be included in a path/reservation message of resource reservation protocol-traffic engineering (RSVP-TE) message.

A network system according to another exemplary embodiment of the present invention includes a first node receiving a command with respect to operation polices of a plurality of MAs that construct a single call and generating a message including information about the operation policies of the plurality of MAs according to the command, and a second node extracting information about the operation policy of an MA corresponding to the second node among the plurality of MAs from the message and setting up an OAM policy of a data plane based on the extracted information.

The message may include identifiers of the plurality of MAs at multiple levels.

The message may include at least one of the IP address of the MEP and the IP address of the R-MEP.

The message may include at least one of information about a continuity check function and information about a performance monitoring function.

The plurality of MAs may be related to one of a plurality of MDs set to multiple levels according to administrators.

The message may include information about the MDs.

The message may be included in a path/reservation message of RSVP-TE.

According to another exemplary embodiment of the present invention, there is provided a network control method performed by a network control device having MDs set to hierarchical levels according to administrators and belonging to at least one of a plurality of MAs that construct a single call, the method including the steps of receiving a command with respect to operation policies of the plurality of MAs, generating a message including information about the operation policies of the plurality of MAs according to the command, and transmitting the message to another network control device.

The message may include at least one of identifiers of the plurality of MAs, information about the MDs, the IP address of the MEP, and the IP address of the R-MEP.

The message may include at least one of information about a continuity check function and information about a performance monitoring function.

According to another exemplary embodiment of the present invention, there is provided a network control method performed by a network control device having MDs set to hierarchical levels according to administrators and belonging to at least one of a plurality of MAs that construct a single call, the method including the steps of receiving a message generated according to a command with respect to operation policies of the plurality of MAs, extracting information about the operation policy of an MA corresponding to the network control device among the plurality of MAs from the message, and setting up an OAM policy of a data plane according to the extracted information.

The message may include at least one of identifiers of the plurality of MAs, information about the MDs, the IP address of the MEP, and the IP address of the R-MEP.

The message may include at least one of information about a continuity check function and information about a performance monitoring function.

According to the present invention, when a single label switched path is provided to multiple service providers or multiple administration domains of a single service provider, different OAMs can be set and efficiently performed according to operation policies and fault situations. Accordingly, it is possible to rapidly detect and handle a fault in a network to enhance the efficiency and flexibility of network operation.

### BRIEF DESCRIPTION OF THE DRAWINGS

FIG. 1 is a block diagram of a network control device according to an exemplary embodiment of the present invention;

FIG. 2 illustrates a network system according to an exemplary embodiment of the present invention;

FIG. 3 illustrates a message transmitted and received by a network control device according to an exemplary embodiment of the present invention; and

FIG. 4 is a flowchart showing a network control method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

A network control apparatus and a network control method according to an exemplary embodiment of the present invention will now be explained in detail with reference to the attached drawings.

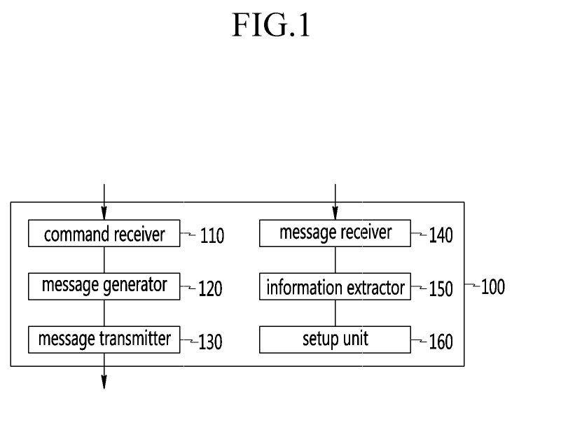

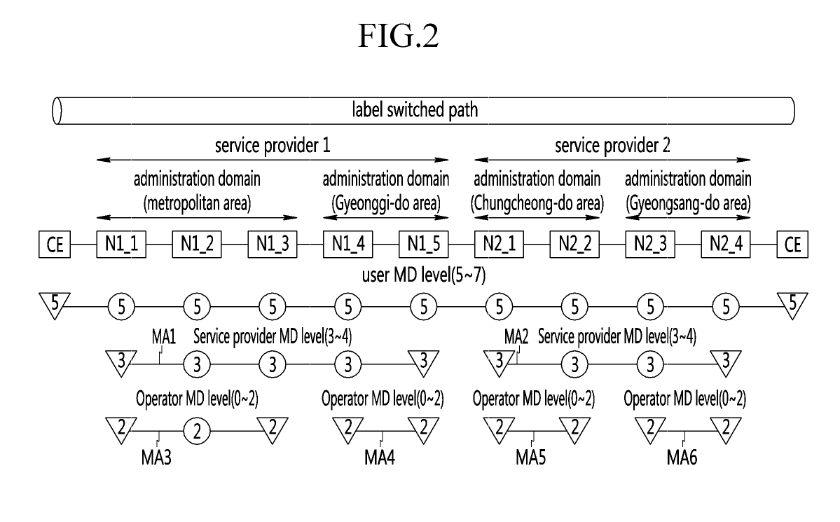

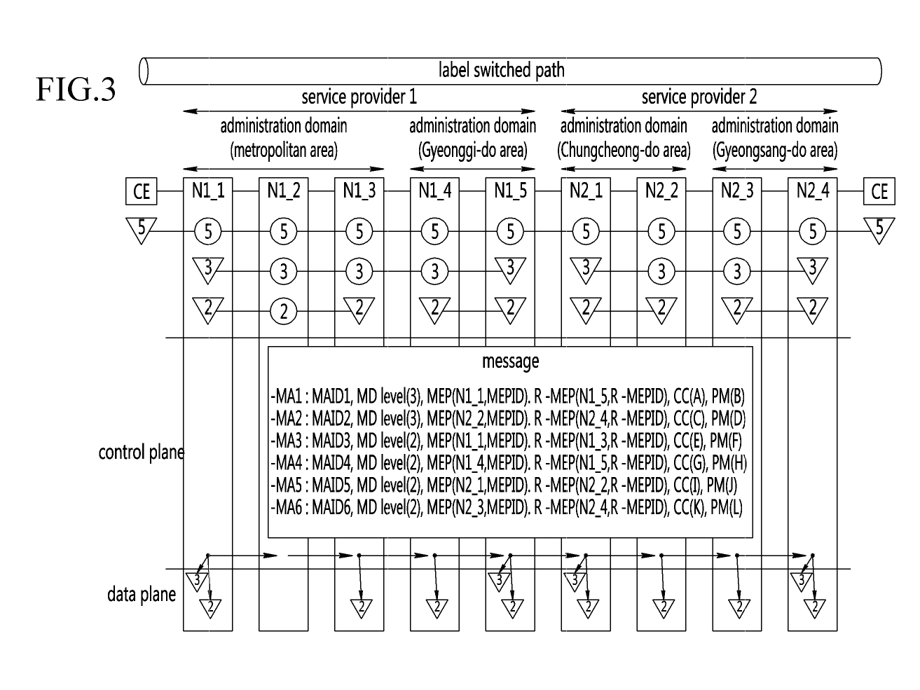

FIG. 1 is a block diagram of a network control device 100 according to an exemplary embodiment of the present invention, FIG. 2 illustrates a network system according to an exemplary embodiment of the present invention, and FIG. 3 illustrates a message transmitted/received by the network control device according to an exemplary embodiment of the present invention.

Referring to FIG. 1, the network control device 100 generates a message having operation information according to a command of an operator, transmits the message to a neighboring network control device, receives a message from the neighboring network control device, and sets up a label switched path based on the message. The network control device 100 may be a router or a switch, and may be represented as a node in a network.

Referring to FIG. 2, a single label switched path may be set up for a plurality of service providers, and a single service provider may have a plurality of administration domains, for example, a metropolitan area, the Gyeonggi-do area, the Chungcheong-do area, and the Gyeongsang-do area.

The label switched path may be set up between two user terminals CE through nine nodes N1_1, N1_2, N1_3, N1_4, N1_5, N2_1, N2_2, N2_3, and N2_4, that is, nine network control devices 100.

In this network, maintenance domains (MDs) may be set up at hierarchical levels for the nodes N1_1, N1_2, N1_3, N1_4, N1_5, N2_1, N2_2, N2_3, and N2_4 according to administrators, and the MDs may be included in at least one of a plurality of maintenance associations (MAs) that construct a single call. For example, a customer level MD can set up an MA with values of 5, 6, and 7, a service provider level MD can set an MA with values of 3 and 4, and the MD level of administration domains of a single service provider, that is, the operator MD level, can set an MA with values of 0, 1, and 2, as shown in FIG. 2.

When the single label switched path is set up for multiple service providers and operators, as described above, operation and maintenance (OAM) functions of the nodes N1_1, N1_2, N1_3, N1_4, N1_5, N2_1, N2_2, N2_3, and N2_4, which are executed on the label switched path, may be different from one another according to operation policies in respective domains.

For example, a first MA MA1 corresponds to MD level 3 that is a service provider level, has a maintenance domain covering the node N1_1 through N1_5, and may have an OAM policy that performs a continuity check every 3 ms and does not execute performance monitoring.

The third MA MA3 corresponds to MD level 2 that is an operator level of a first service provider, has a maintenance domain under the jurisdiction of the metropolitan area from the node N1_1 to the node N1_3, and may have an OAM policy that performs a continuity check every 10 ms and does not execute performance monitoring.

The fourth MA MA4 corresponds to MD level 2 that is the operator level of the first service provider, has a maintenance domain under the jurisdiction of the Gyeonggi-do area covering the nodes N1_4 and N1_5, and may have an OAM policy that performs a continuity check every 3 ms and executes performance monitoring.

As described above, while the third MA MA3 and the fourth MA MA4 are included in the same service provider, OAM functions and operations of the third MA MA3 and the fourth MA MA4 may be different from each other according to network characteristics and operation policy of the operator.

Accordingly, the nodes N1_1, N1_2, N1_3, N1_4, N1_5, N2_1, N2_2, N2_3, and N2_4 included in the single label switched path may execute different OAM functions. That is, the node N1_3 performs continuous checking while functioning as a maintenance association end point (MEP) in the third MA MA3 even though the node N1_3 does not carry out a continuity check and performance monitoring while functioning as a maintenance association intermediate point (MIP) in the first MA MA1. The node N1_5 performs a continuity check and does not carry out performance monitoring while serving as an MEP in the first MA MA1 even though the node N15 performs both a continuity check and performance monitoring while functioning as an MPE in the fourth MA MA4. The node N2_3 does not perform a continuity check and performance monitoring while serving as an MIP in the second MA MA2 even though the node N2_3 performs a continuity check and does not carry out performance monitoring while functioning as an MEP in the fifth MA MA5.

The nodes N1_1, N1_2, N1_3, N1_4, N1_5, N2_1, N2_2, N2_3, and N2_4 included in the single label switched path have different functions as the MEP or MIP and different OAM functions according to MDs to which the nodes belong and the levels of the MDs.

Referring back to FIG. 1, the network control device 100 includes a command receiver 110, a message generator 120, a message transmitter 130, a message receiver 140, an information extractor 150, and an OAM setup unit 160.

The command receiver 110 receives a command with respect to operation policies of respective MAs from a service provider or an operator.

The message generator 120 generates a message including information on the operation policies of the MAs according to the command received by the command receiver 110. Here, the message may be a path/reservation message of resource reservation protocol-traffic engineering (RSVP-TE).

The message generated by the message generator 120 may have a structure shown in FIG. 3, for example.

Referring to FIG. 3, the message generator 120 is included in a control plane that controls the operation of the network control device 100, and the message includes identifiers MAID and MD levels of MAs, IP addresses of MEPs, IP address of remote maintenance association end points (R-MEP), and information on continuity check and performance monitoring.

For example, the first MA MA1 has an identifier MAID1, an MEP corresponding to the node N1_1, and an R-MEP corresponding to the node N1_5 and belongs to the MD level 3, the second MA MA2 has an identifier MAID2, an MEP corresponding to the node N2_2, and an R-MEP corresponding to the node N2_4 and belongs to the MD level 3, the third MA MA3 has an identifier MAID3, an MEP corresponding to the node N1_1, and an R-MEP corresponding to the node N1_3 and belongs to the MD level 2, the fourth MA MA4 has an identifier MAID4, an MEP corresponding to the node N1_4, and an R-MEP corresponding to the node N1_5 and belongs to the MD level 2, and the sixth MA MA6 has an identifier MAID6, an MEP corresponding to the node N2_3, and an R-MEP corresponding to the node N2_4 and belongs to the MD level 2. Various conditions for continuity check and performance monitoring may be set up for the first through sixth MAs MA1 through MA6.

The message transmitter 130 transmits the message generated by the message generator 120 to a neighboring network control device, that is, a neighboring node in FIG. 2.

The message receiver 140 receives a message including operation policy information on MAs from a neighboring network control device, that is, a neighboring node in FIG. 2.

The information extractor 150 extracts operation policy information about an MA corresponding to the network control device 100 from the message received by the message receiver 140.

The OAM setup unit 160 sets up a data plane for processing actual data according to the information extracted from the message by the information extractor 150 to perform an OAM function according to the information.

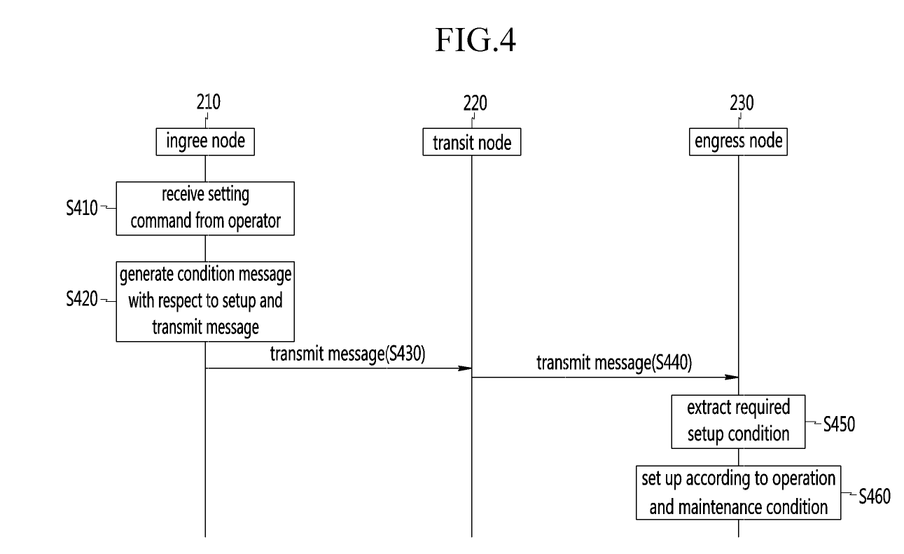

A network control method according to an exemplary embodiment of the present invention will now be explained with reference to FIG. 4.

FIG. 4 is a flowchart showing the network control method according to an exemplary embodiment of the present invention.

Referring to FIG. 4, an ingress node 210 receives a setting command from an operator in step S410. The setting command means a command with respect to the operation policy of each MA, and the ingress node 210 may be an MEP, for example, the first node N1_1 shown in FIG. 2.

Then, the ingress node 210 generates a message corresponding to the received setting command in step S420. Here, the message includes information about the operation policy of each MA as described above with reference to FIG. 3.

The ingress node 210 transmits the message to a transit node 220 in step S430. The transit node 220 is an MIP, and may correspond to the node N1_2 that neighbors the node N1_1 in FIG. 2, for example.

The transmit node 220 transmits the received message to a neighboring egress node 230 in step 440. The egress node 230 is an R-MEP, and may correspond to the node N1_3 shown in FIG. 2, for example.

The egress node 230 extracts a setup condition corresponding to the egress node 230, that is, information about the operation policy of an MA corresponding to the egress node 230, from the message in step S450.

Then, the egress node 230 sets an OAM mode in a data plane according to the extracted information, that is, operation maintenance conditions, in step S460.

The egress node 230 may transmit a reservation message according to the extracted information to the transit node 220, and the transmit node 220 may transmit the received reservation message to the ingress node 210.

As described above, when network control devices are set up such that neighboring network control devices respectively generate messages including different operation policies for respective MAs, and transmit/receive the messages to/from each other, the network control devices can efficiently set and perform different OAMs according to operation policies and fault situations when a single label switched path is provided to multiple service provider domains or multiple administration domains of a single service provider. Accordingly, a fault in a network can be rapidly detected and handled so as to enhance the efficiency and flexibility of network operation.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A network control device comprising:
a command receiver receiving a command with respect to operation policies of a plurality of maintenance associations (MAs) that construct a single call;
a message generator generating a message comprising information about the operation policies of the plurality of MAs according to the command; and
a message transmitter transmitting the message to a neighboring network control device.

2. The network control device of claim 1, further comprising:
a message receiver receiving the message from the neighboring network control device;
an information extractor extracting information about the operation policy of an MA corresponding to the network control device among the plurality of MAs from the message; and
a setup unit setting up an operation and maintenance (OAM) policy in a data plane according to the extracted information.

3. The network control device of claim 2, wherein the message comprises identifiers of the plurality of MAs.

4. The network control device of claim 3, wherein the message comprises at least one of the Internet protocol (IP) address of a maintenance association end point (MEP) and the IP address of a remote maintenance association end point (R-MEP).

5. The network control device of claim 2, wherein the message comprises at least one of information about a continuity check function and information about a performance monitoring function.

6. The network control device of claim 2, wherein the plurality of MAs are related to one of a plurality of maintenance domains (MDs) set to multiple levels according to administrators.

7. The network control device of claim 6, wherein the message comprises information about MDs with respect to the plurality of MAs.

8. The network control device of claim 1, wherein the message is comprised in a path/reservation message of resource reservation protocol-traffic engineering (RSVP-TE).

9. A network control device comprising:
a message receiver receiving a message comprising information about the operation policies of the plurality of maintenance associations (MAs) that construct a single call from the neighboring network control device;
an information extractor extracting information about the operation policy of an MA corresponding to the network control device among the plurality of MAs from the message; and
a setup unit setting up an operation and maintenance (OAM) policy in a data plane according to the extracted information.

10. The network system of claim 9, wherein the message comprises identifiers of the plurality of MAs.

11. The network system of claim 9, wherein the message comprises at least one of the Internet protocol (IP) address of a maintenance association end point (MEP) and the IP address of a remote maintenance association end point (R-MEP).

12. The network system of claim 10, wherein the message comprises at least one of information about a continuity check function and information about a performance monitoring function.

13. The network system of claim 10, wherein the plurality of MAs are related to one of a plurality of maintenance domains (MDs) set to multiple levels according to administrators.

14. The network system of claim 13, wherein the message comprises information about the MDs.

15. The network system of claim 9, wherein the message comprised in a path/reservation message of resource reservation protocol-traffic engineering (RSVP-TE).

16. A network control method performed by a network control device having maintenance domains (MDs) set to hierarchical levels according to administrators and belonging to at least one of a plurality of maintenance associations (MAs) that construct a single call, the method comprising the steps of:
receiving a command with respect to operation policies of the plurality of MAs;
generating a message comprising information about the operation policies of the plurality of MAs according to the command; and
transmitting the message to another network control device.

17. The network control method of claim 16, wherein the message includes at least one of identifiers of the plurality of MAs, information about the MDs, the Internet protocol (IP) address of a maintenance association end point (MEP), and the IP address of a remote maintenance association end point (R-MEP).

18. The network control method of claim 16, wherein the message includes at least one of information about a continuity check function and information about a performance monitoring function.

19. A network control method performed by a network control device having maintenance domains (MDs) set to hierarchical levels according to administrators and belonging to at least one of a plurality of maintenance associations (MAs) that construct a single call, the method comprising the steps of:
receiving a message generated according to a command with respect to operation policies of the plurality of MAs;
extracting information about the operation policy of an MA corresponding to the network control device among the plurality of MAs from the message; and
setting up an operation and maintenance (OAM) policy of a data plane according to the extracted information.

20. The network control method of claim 19, wherein the message includes at least one of identifiers of the plurality of MAs, information about the MDs, the IP address of a maintenance association end point (MEP), and the IP address of a remote maintenance association end point (R-MEP).
